(19) United States
(12) Patent Application Publication
(10) Pub. No.: US 2023/0184572 A1
(43) Pub. Date: Jun. 15, 2023

(54) ULTRASONIC WATER METER

(71) Applicant: Youngtak KIM, Incheon (KR)

(72) Inventor: Youngtak KIM, Incheon (KR)

(21) Appl. No.: 17/758,987

(22) PCT Filed: Mar. 24, 2021
(86) PCT No.: PCT/KR2021/003667

§ 371 Date: Jan. 27, 2023

(30) Foreign Application Priority Data
Apr. 3, 2020 (KR) 10-2020-0040880

(51) Int. Cl. G01F 1/66

(52) U.S. Cl. CPC G01F 1/662

(57) ABSTRACT

The ultrasonic water meter of the present invention relates to an ultrasonic water meter that has a structure in which ultrasonic sensors are directly disposed in a pipe, that is of an full-electronic type that minimizes the influence of an air layer that may occur in a water pipe and uses a highly reliable measurement conduit without a water flow path difference depending on the location of the water flow inside a measurement conduit, and that has the smart meter function of displaying water usage information and information indicating the operation status and usage status of the meter on the liquid crystal device (LCD) of the meter and having a communication means for providing the information to a remote management system.

### TECHNICAL FIELD

The present invention relates to an ultrasonic water meter that measures the amount of tap water by using the difference between the propagation time of ultrasonic waves in a forward direction and the propagation time of ultrasonic waves in a reverse direction by means of the characteristic in which, when water flows through a pipe, the propagation speed of ultrasonic waves propagating in water increases in a direction identical to the direction in which the water flows, i.e., in a forward direction, and decreases in the direction reverse to the direction in which water flows.

### BACKGROUND ART

An ultrasonic water meter contains a built-in ultrasonic transducer that has the function of generating ultrasonic waves and detecting ultrasonic waves being transmitted. When a sensor block including a housing with a structure configured to be coupled to a pipe is referred to as an ultrasonic sensor hereinafter, a measurement conduit is formed in a specific part of the pipe. Two ultrasonic sensors may be directly disposed in the measurement conduit through which water flows, or two reflectors may be used to form an ultrasonic wave propagation line in the measurement conduit and the ultrasonic sensor on one side generates ultrasonic waves. When the ultrasonic sensors facing each other receive ultrasonic waves, the amount of water passed through the pipe is measured by measuring the flow of water in the measurement conduit and the propagation times in reverse and forward directions, obtaining the speed of water flow using the difference between the propagation times, and integrating products of the speed of the water flow and the cross-sectional area of the pipe.

### DISCLOSURE

### Technical Problem

The propagation speed of ultrasonic waves in air at room temperature is 343 m/sec, and the propagation speed of ultrasonic waves in water is 1480 m/sec. The difference in the propagation speed of ultrasonic waves may be significant depending on whether a medium in the measurement conduit having a measurement distance between ultrasonic sensors is air or water.

When there is more than a specific amount of air in the measurement conduit of an ultrasonic water meter, the measurement speed of an ultrasonic sensor in this measurement conduit may be detected as speed in air or speed in water. Based on the propagation speed in water, measurement becomes impossible when the ultrasonic measurement speed in the air is detected, whereas a measurement result will be unreliable when the measurement speed of water is detected. The installation environment of household water meters is very diverse. When air flows into the measurement conduit of the ultrasonic water meter and affects measurement due to the condition of a conduit or the flow of water, such as the cutoff of water supply or reverse flow, an ultrasonic water meter, which is an electronic meter, will report a sensor failure when the ultrasonic signal is out of the detection range, or display an unreliable measurement value when it is within the detection range.

### Technical Solution

In the following description, a structure in which a measurement conduit (14) has a central axis (31) having a difference (a) in height than the central axis (30) of an inflow conduit (20) and an outflow conduit (21) (hereinafter referred to as connection conduits (20 and 21) in a downward direction and parallel to the central axis (30) and ultrasonic sensors (10 and 11) placed at both ends of the measurement conduit (14) face each other and are disposed in a straight pipe when viewed from the front, as shown in FIG. 1-A of FIG. 1, is called a U-type measurement pipe. An ultrasonic sensor straight pipe-type structure in which the central axis (33) of the connection conduits (20 and 21) and the central axis (32) of the measurement conduit (15) are inclined at a specific angle when viewed from the top, as shown in FIG. 1-B of FIG. 1, is called an X-shaped measurement pipe. A connection hole in a portion in which the inflow conduit is coupled to the horizontal measurement conduit or a connection hole for the measurement conduit of the upstream inlet and the outflow conduit is called a downstream outlet (26).

It is not possible to construct an ultrasonic sensor straight pipe type measurement conduit in a small-diameter ultrasonic measurement pipe such as that of a water meter without the deformation of the pipe. Accordingly, there is used a reflective plate-type ultrasonic water meter in which a measurement conduit is constructed by deforming a pipe like a U-shaped measurement pipe or an X-shaped measurement pipe or by disposing two ultrasonic sensors in the upper part of a horizontal pipe and also disposing two ultrasonic reflective plates in the flow path of the horizontal pipe under the sensors to face each other. The characteristics of the reflective plate-type measurement conduit are not different from those of the X-shaped measurement pipe in the following description.

The present invention is intended to suggest a solution to the problems by identifying the characteristics and problems of the U-shaped and X-shaped measurement pipes in the case where an air layer is present in a water flow path in a measurement conduit and the measurement conduit.

Referring to FIG. 1, when the water introduced through the inflow conduit flows to the outflow conduit through the measurement conduit, the flow of water in a horizontal direction, which is the same as the direction of ultrasonic waves, in the measurement conduit will be discussed. In the case of the U-shaped measurement pipe of FIG. 1-A of FIG. 1, an upstream inlet (25) and a downstream outlet (26) are located in the measurement conduit (14) in the same direction above the axis (31) of the measurement conduit (14). Accordingly, the horizontal movement distance of the water flow in the measurement conduit (14) varies, as at a1, b1, and c1, depending on the location thereof. It appears as a1=L1, b1=a1+d1, and c1=a1+2d1. In a small-diameter measurement pipe such as that of a water meter, the value of d1 becomes 10% or more of L1, which is a large value that cannot be ignored. Even at the same flow rate, the propagation speed of ultrasonic waves may vary depending on the propagation path of the ultrasonic waves detected in the measurement conduit (14). Therefore, the present invention has a structure that can cause errors in measurement values.

In contrast, when the X-shaped measurement pipe of FIG. 1-B of FIG. 1 is installed horizontally, the measurement conduit (15) of the X-shaped measurement pipe viewed from the top has the upstream inlet (25) and the downstream outlet (26) that are located in the opposite direction of the axis (32) of the measurement conduit (15). Accordingly, the horizontal movement distance of the water flow in the measurement conduit (14) is the same as at a2, b2, and c2 regardless of the position thereof in a pipe, and thus it appears as a2=L2+d2, b2=L2+d2, and c2=L2+d2. Therefore, there is no variation in the propagation path of ultrasonic waves in the measurement conduit (15), so that excellent measurement performance is achieved.

Referring to FIG. 2, the influence of a case where there is an air layer in a water pipe when the water introduced through an inflow conduit flows to an outflow conduit through a measurement conduit on the measurement conduit will be described below.

When an ultrasonic water meter is installed in a water pipe through which water flows, when there is an effect that may cause air to enter the pipe, such as the reverse flow of water, and thus an air layer is generated or is present in an ultrasonic measurement conduit, or when the installation location of the ultrasonic water meter is higher than a faucet and the pressure applied to the pipe is low and thus the water flowing to an outlet is small, water may flow only to the lower part of the pipe in a state in which a certain air layer is formed inside the pipe. In this case, in the case of the X-shaped measurement pipe, such as that shown in FIG. 2-A of FIG. 2, in which an ultrasonic measurement pipe is installed horizontally in the pipe, the measurement becomes impossible or unreliable measured values are obtained depending on the size of the air layer. In the case of the U-shaped measurement conduit (14), such as that shown in FIG. 2-B of FIG. 2, even when water flows under the air layer through the inflow conduit (20) and the outflow conduit (21), the measurement conduit (14) is filled with water. Accordingly, excellent measurement performance is achieved even when an air layer is generated in the pipe. It can be seen from the U-shaped measurement pipe or

X-shaped measurement pipe in the above-mentioned straight pipe-type measurement pipe in which ultrasonic sensors are disposed to face each other that the U-shaped measurement pipe is excellent when there is an air layer in the pipe, but is problematic in that there is a difference in the path of the water flow depending on the location in the measurement conduit (14) and that the X-shaped measuring pipe is advantageous in that there is no difference in the path of the water flow depending on the location in the measurement conduit (15), but is problematic in that there is a problem in the measurement when there is an air layer in the pipe. Ideally, there is always high water pressure in the water pipe. Accordingly, even when an air layer is generated therein, it is normal for air to be discharged when tap water is used and for the pipe to be filled with water. In reality, there are frequent cases where it is not the case. Although an impeller driven mechanical water meter is recognized as operating even when air flows in a conduit, an electronic ultrasonic meter is detected as having an abnormality of the ultrasonic sensor and reports a fault condition, and is converted into a normal state when air is discharged from the pipe due to normal water flow, thereby causing confusion to a user.

The present invention proposes, as a scheme for overcoming the above-described problems, an ultrasonic water meter with increased reliability through a measurement pipe in which there is no difference in the path of the water flow in the measurement conduit (15). The structure of the ultrasonic measurement pipe is configured such that the upper form of a U-shaped measurement pipe is taken by configuring connection conduits (20 and 21) and the measurement conduits (15) and the lower ultrasonic measurement conduit (15) takes the form of the measurement conduit of the X-shaped measurement pipe, as shown in FIG. 3-A of FIG. 3. Accordingly, when viewed from the front as shown in FIG. 3-C of FIG. 3, the measurement conduit (15) forms a lower difference (a) in height with the connection conduits (20 and 21), thereby overcoming the problem of an air layer in the pipe. Furthermore, when viewed from the top as shown in FIG. 3-B of FIG. 3, the central axis (18) of the connection conduit and the central axis (19) of the measurement conduit form a specific slant angle θ, and the upstream inlet (25) and downstream outlet (26) of the measurement conduit (16) are located at both side ends of the measurement conduit (16).

### Advantageous Effects

The ultrasonic water meter of the present invention enables the practice of an ultrasonic water meter that has a structure in which ultrasonic sensors are directly disposed in a pipe, that is of an full-electronic type that minimizes the influence of an air layer that may occur in a water pipe and uses a highly reliable measurement conduit without a water flow path difference depending on the location of the water flow inside a measurement conduit, and that has the smart meter function of displaying water usage information and information indicating the operation status and usage status of the meter on the liquid crystal device (LCD) of the meter and having a communication means for providing the information to a remote management system.

### DESCRIPTION OF DRAWINGS

FIG. 1 shows the paths of water flowing inside measurement conduits according to the positions of an upstream inlet (25) and a downstream outlet (26) in the measurement conduit (14) of the U-shaped ultrasonic measurement pipe of FIG. 1-A and the measurement conduit (15) of the X-shaped ultrasonic measurement pipe of FIG. 1-B;

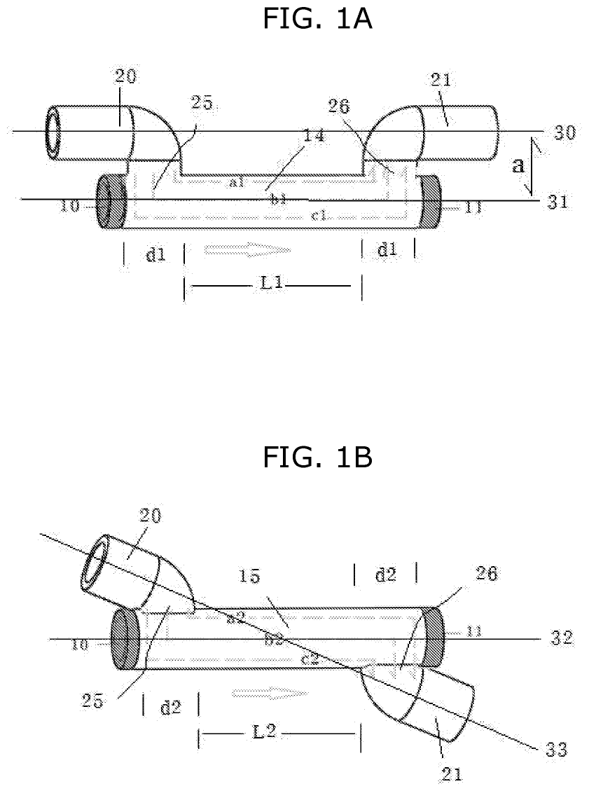

FIG. 2 shows the states of measurement conduits when an air layer is formed in connection conduits in the measurement conduit (14) of the X-shaped measurement pipe of FIG. 2-A in which connection conduits (20, and 21) and a measurement conduit (15) are horizontal and in the measurement conduit (14) of the U-shaped measurement pipe of FIG. 2-B in which connection conduits (20, and 21) and a measurement conduit (14) have a difference (a) in height;

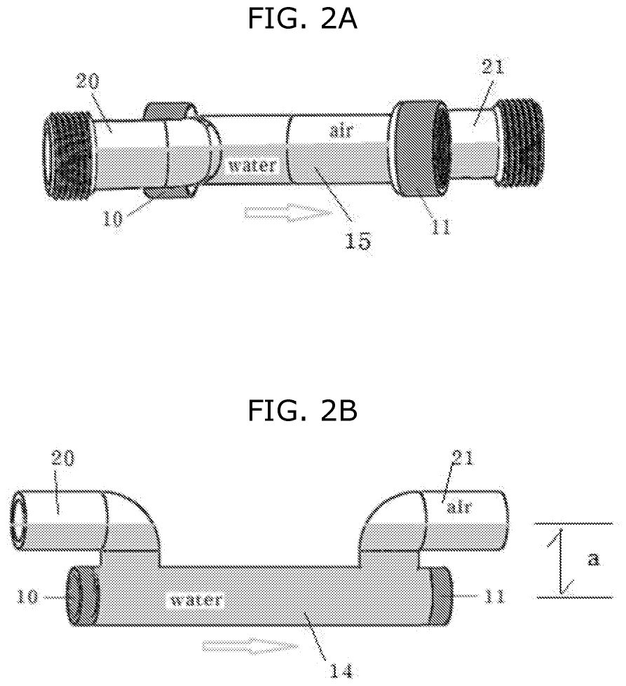

FIG. 3 shows views of the shape of the measurement pipe of the ultrasonic water meter of the present invention and ultrasonic sensors coupled to both ends (12 and 13) of the measurement conduit, wherein FIG. 3-A is a perspective view of the measurement pipe, FIG. 3-B is a diagram viewed from the top, FIG. 3-C is a diagram viewed from the front, and FIG. 3-D is a diagram of an example of the coupling structure of an ultrasonic sensor;

In FIG. 4, FIG. 4-A shows a combined structure in which an ultrasonic water meter according to the invention is fabricated in the state of being divided into an inflow part (34), an measurement conduit part (35), and an outflow part (36), and FIG. 4-B shows the coupling surface of the inflow part (34) and the measurement conduit part (35) and the horizontal cut surface (38) of a water channel (41) formed in a coupling portion through which water flows from an inflow pipe to an upstream inlet (25) in the combined structure shown in FIG. 4-A; and

FIG. 5 shows the shape of the measurement pipe of the ultrasonic water meter according to the present invention and a functional block diagram of contained functions in FIG. 5-A.

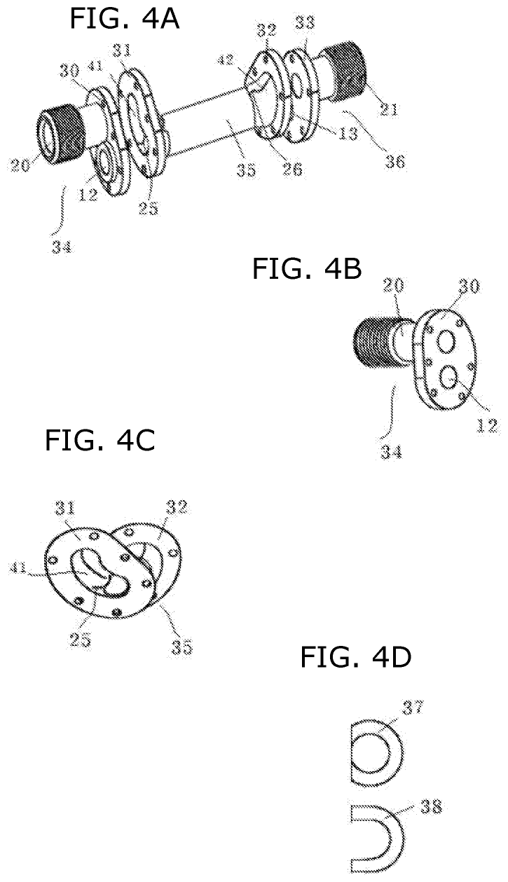

### BEST MODE

In an ultrasonic water meter, a fluid flowing through a conduit is water and a flow rate is Q=A*V.

A=the cross-sectional area of the conduit through which the fluid flows, and V=the velocity of the fluid.

Assuming that the distance between ultrasonic sensors 10 and 11 in a measurement conduit 15=L, the ultrasonic propagation speed from the upstream ultrasonic sensor 10 to the downstream ultrasonic sensor 11=T12, the ultrasonic propagation speed from the downstream ultrasonic sensor 11 to the upstream ultrasonic sensor 10=T21, and ΔT=T21−T12, V=L/2*(1/T12−1/T21)=L/2*(T21−T12)/T12*T21=L/2*ΔT/(T12*T21), where the velocity V is the absolute value of a calculated value. The flow rate in the ultrasonic water meter is calculated by knowing the cross-sectional area A of the measurement conduit 15 and the distance L between the ultrasonic sensors and measuring the ultrasonic propagation times T12 and T21 between the ultrasonic sensors 10 and 11.

The diameter A and length L of the measurement conduit 15 are determined by standard conditions based on the maximum flow rate and minimum flow rate according to the diameter of a water pipe to which the ultrasonic measurement conduit is connected, the diameter and ultrasonic propagation characteristics of the ultrasonic sensors used, the electronic circuit of an electronic part, and the processing capability of operation software. Since more precise measurement can be achieved as the change in the velocity V attributable to the change in the flow velocity becomes greater, the diameter of the measurement conduit 15 is determined to be smaller than the diameter of the connected water pipe within a possible range.

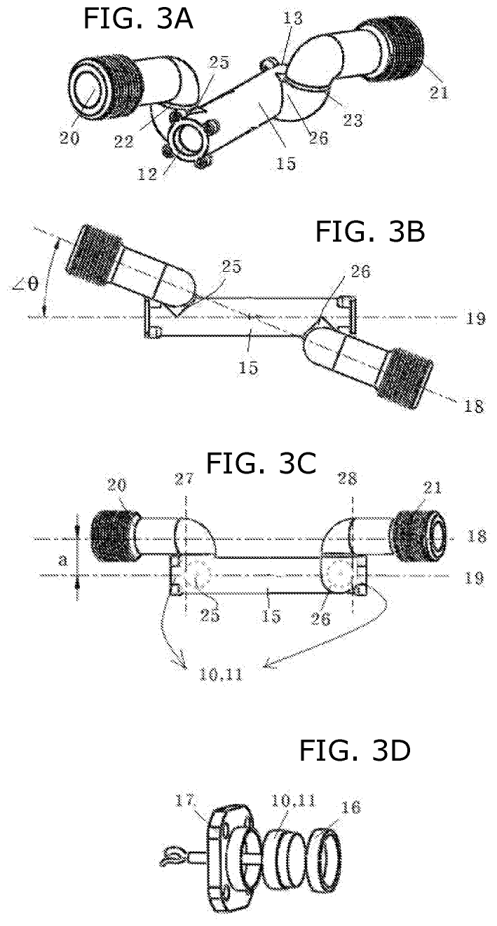

When the measurement conduit of the ultrasonic water meter of the present invention is described with reference to FIG. 3, an upstream inlet 25 is disposed in the upstream side of the measurement conduit 15 and a downstream outlet 26 is disposed in the corresponding downstream side thereof, an inflow conduit 20 and an outflow conduit 21 that are disposed on the straight line of a connection axis 18 have a difference ‘a’ in height in the horizontal height direction than the measurement conduit 15 as shown in the front view of FIG. 3-C, and the axis 19 of the measurement conduit and the axis 18 of the connection conduit form a specific slant angle θ when viewed from the top, as shown in the figure of FIG. 3-B. The slant angle θ may be determined to be a value within a range of 10 to 50 degrees depending on the diameter of the measurement conduit. The inflow conduit forms a curved conduit portion 22 facing the upstream inlet 25 on the side of the measurement conduit 15 while extending downward and is connected to the upstream inlet 25 of the measurement conduit 15, and the outflow conduit 21 forms a curved conduit portion 23 facing the downstream outlet 26 on a side of the measurement conduit 15 while extending downward and is connected to the downstream inlet 26 of the measurement conduit 15. The ultrasonic water meter of the present invention fabricated in the above-described manner exhibits the completed appearance of FIG. 3-A. When waterproof coupling into ultrasonic sensor reception holes 12 and 13 at both ends of the measurement conduit 15 is performed using a housing 17 into which an O-ring 16 and an ultrasonic transducer 10 or 11 are coupled, as shown in FIG. 3-D, the ultrasonic measurement conduit is completed.

### MODE FOR INVENTION

The ultrasonic measurement conduit designed as shown in FIG. 3-A may be made of a metal material such as a brass material or a stainless material, or a high-strength plastic material, and the portion between the inflow conduit 20 and the measurement conduit 15 and the portion between the outflow conduit 21 and the measurement conduit 15 are formed as the curved conduit portions 22 and 23. Accordingly, when an inflow part 34, a measurement conduit part 35, and an outflow part 36 are fabricated separately and then combined together such that there is no curved pipe in each part as shown in FIG. 4-A to improve the efficiency of a manufacturing process, it may be possible to reduce manufacturing cost and improve manufacturing efficiency during mold manufacturing, injection, and processing. When the separately fabricated measurement conduit is divided into parts without a curved conduit portion by using the cutting the upstream cutting line 27 and downstream cutting line 28 of the measurement conduit 15 of FIG. 3-C as reference planes, flanges 30, 31, 32, and 33 are formed in respective cut portions, and division and formation into the inflow part 34, the measurement conduit 35, and the outflow part 36 are performed as shown in FIG. 4-A, the inflow part 34 and the outflow part 36 may have the same shape. When cutting is performed using the upstream cutting line 27 and the downstream cutting line 28 as reference planes, the horizontal sectional views of the downwardly curved pipe parts 25 and 26 of the measurement conduit part have the channel shape of a cut plane as shown in 37 of FIG. 4-B. Accordingly, for the convenience of a manufacturing process, the structure is modified such that they have a channel shape such as that shown in 38 of FIG. 4-C.

When the ultrasonic measurement conduit is manufactured as described above, there is provided the function of a full-electronic smart water meter in which the signal lines of the ultrasonic sensors are connected to the electronic circuit, information about the quantity of water passing through the conduit, the presence or absence of abnormality in the ultrasonic sensor, water leakage, overload, and non-use status is collected by detecting the speed of the water flow in the measurement conduit through the operation of the electronic circuit part and built-in operating software, and the collected information is displayed on an LCD and provided to a remote meter reading system via wired/wireless communication means.

### INDUSTRIAL APPLICABILITY

The water meter of the present invention can be viewed as an item that is used in all households that receive the supply of drinking water from water supply facilities.
10, 11: ultrasonic transducer
12, 13: ultrasonic sensor coupler, 14: U-shaped measurement conduit, 15: X-shaped measurement conduit
16: O-ring, 17: ultrasonic transmission and reception housing
18: central axis of connection conduit (20+21), 19: central axis of measurement conduit
20: inflow conduit, 21: outflow conduit
22: downwardly curved portion of inflow conduit, 23: downwardly curved portion of outflow conduit
25: upstream inlet of measurement conduit, 26: downstream outlet of measurement conduit
27, 28: cutting portion for separate manufacturing of measurement pipe
30: inflow part flange, 31, 32: measurement conduit part flange, 33: outflow part flange
34: inflow part, 35: measurement conduit part, 36: outflow part
37: cross-sectional view of downwardly curved portion in the case of cutting of 27, 37
38: cross-sectional view of downstream channel of modified product of 37
41: upstream channel from inflow pipe to upstream inlet
42: downstream channel from downstream outlet to outlet pipe
a: difference in height between connection conduits 20, and 21 and measurement conduit

1. An ultrasonic water meter for measuring an amount of water passing through a pipe using a propagation speed of ultrasonic waves in water with an ultrasonic measurement pipe connected to a water pipe, wherein:
a. the measurement pipe has a measurement conduit, an inflow conduit, and an outflow conduit;
b. the measurement conduit is composed of a straight conduit, ultrasonic sensors are inserted and fastened in a structure corresponding to each other and directly inserted into a pipe at both ends of the measurement conduit, the inflow conduit and the outflow conduit form a downward difference (a) in height than the measurement conduit, a connection axis connecting the inflow conduit and the outflow conduit forms a straight line, and the connection axis and an axis of the measurement conduit form a specific slant angle of 10 to 50 degrees when viewed from a top; and
c. the inflow conduit forms a downwardly curved pipe and is connected to an upstream inlet in a side of an upstream end of the measurement conduit, and the outlet conduit forms a downwardly curved pipe and is connected to a downstream outlet in a side opposite to the upstream inlet at a downstream end of the measurement conduit;
so that the ultrasonic water meter measures an amount of water using times when a water flow and ultrasonic waves are in forward directions and in reverse directions in the measurement conduit.

2. The ultrasonic water meter of claim 1, wherein the ultrasonic water meter is fabricated in a state of being divided into parts of an inflow part (34), a measurement conduit pipe (35), and an outflow part (36), as shown in FIG. 4-A of FIG. 4, and then the parts are combined into the ultrasonic water meter.

3. The ultrasonic water meter of claim 1, wherein an axis connecting the inflow conduit and outflow conduit of the measurement pipe of the ultrasonic water meter lies on a straight line and forms a downward difference in height than the measurement conduit, and an inlet portion of the inflow conduit connected to the measurement conduit and an outlet portion of the outflow conduit connected to the measurement conduit are respectively formed on opposite sides of a horizontal direction at both ends of the measurement conduit.
